(19) United States
(12) Patent Application Publication
(10) Pub. No.: US 2024/0260726 A1
(43) Pub. Date: Aug. 8, 2024

(54) PROTECTIVE CASE AND ELECTRONIC DEVICE

(71) Applicant: Shenzhen Maikeke Technology Co., Ltd, Shenzhen (CN)

(72) Inventor: Zhihua Li, Shenzhen (CN)

(21) Appl. No.: 18/122,702

(22) Filed: Mar. 16, 2023

(30) Foreign Application Priority Data
Feb. 7, 2023 (CN) 202320273682.8

(51) Int. Cl. A45C 11/00

(52) U.S. Cl. CPC A45C 11/00; A45C 2011/002; A45C 2011/003

(57) ABSTRACT

The present disclosure provides a protective case and an electronic device. The protective case includes a bottom wall and a side wall, the side wall is connected with the bottom wall to define a receiving space. The bottom wall includes a step configured for supporting the electronic device, and a first gap is defined between the bottom wall of the protective case and a bottom wall of the electronic device when the electronic device is received in the receiving space.

### CROSS REFERENCE TO RELATED APPLICATIONS

The present application claims the benefit of Chinese Patent Application No. 202320273682.8 filed on Feb. 7, 2023, the contents of which are incorporated herein by reference in their entirety.

### FIELD

The present disclosure relates to electronic devices, and in particular to a protective case and an electronic device.

### BACKGROUND

The protective cases are used to cover and protect the electronic devices. The electronic device usually contacts with the bottom wall and the side wall of the protective case, the heat dissipation of the electronic device is severe, and the moisture may attach on the electronic device to form water stains.

### SUMMARY

In a first aspect, the present disclosure provides a protective case which includes a bottom wall and a side wall, the side wall is connected with the bottom wall to define a receiving space. The bottom wall includes a step configured for supporting the electronic device, and a first gap is defined between the bottom wall of the protective case and a bottom wall of the electronic device when the electronic device is received in the receiving space.

In a second aspect, the present disclosure provides an electronic device which includes a housing and the protective case, the housing is detachably received in the receiving space.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a structure diagram of a protective case and an electronic device according to a first embodiment of the present disclosure;

FIG. 2 is a structure diagram of the protective case in FIG. 1;

FIG. 3 is an enlarged diagram of portion A in FIG. 2;

FIG. 4 is an enlarged diagram of portion B in FIG. 2;

FIG. 5 is a cross sectional diagram of the protective case and the electronic device in FIG. 1;

FIG. 6 is an enlarged diagram of portion C in FIG. 5;

FIG. 7 is an enlarged diagram of portion D in FIG. 5;

FIG. 8 is another cross sectional diagram of the protective case and the electronic device in FIG. 1;

FIG. 9 is an enlarged diagram of portion E in FIG. 8;

FIG. 10 is another structure diagram of the protective case in FIG. 1;

FIG. 11 is an enlarged diagram of portion F in FIG. 10;

FIG. 12 is a further structure diagram of the protective case in FIG. 1;

FIG. 13 is an enlarged diagram of portion G in FIG. 12;

FIG. 14 is a structure diagram of a protective case according to a second embodiment of the present disclosure;

FIG. 15 is an enlarged diagram of portion H in FIG. 14;

FIG. 16 is another structure diagram of the protective case in FIG. 14; and

FIG. 17 is an enlarged diagram of portion I in FIG. 16.

The realization of the aim, functional characteristics, advantages of the present disclosure are further described specifically with reference to the accompanying drawings and embodiments.

### DETAILED DESCRIPTION

The technical solutions of the embodiments of the present disclosure will be clearly and completely described in the following with reference to the accompanying drawings. It is obvious that the embodiments to be described are only a part rather than all of the embodiments of the present disclosure. All other embodiments obtained by persons skilled in the art based on the embodiments of the present disclosure without creative efforts shall fall within the protection scope of the present disclosure.

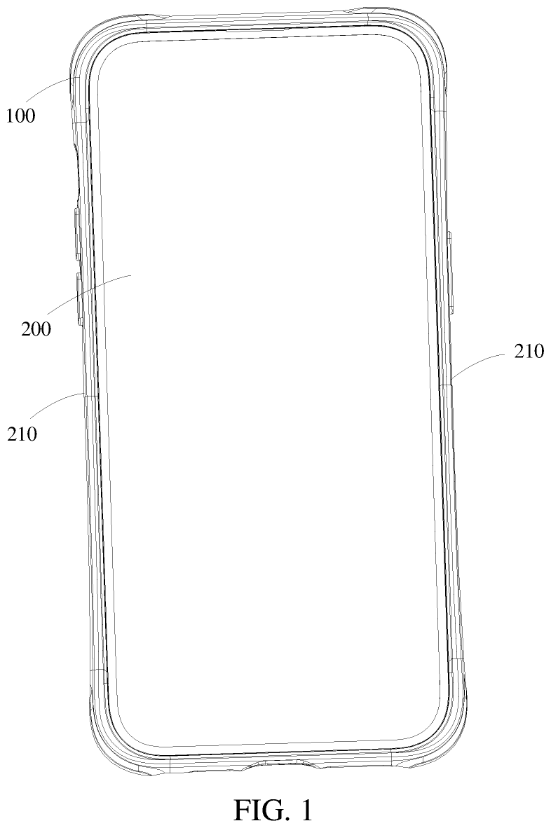

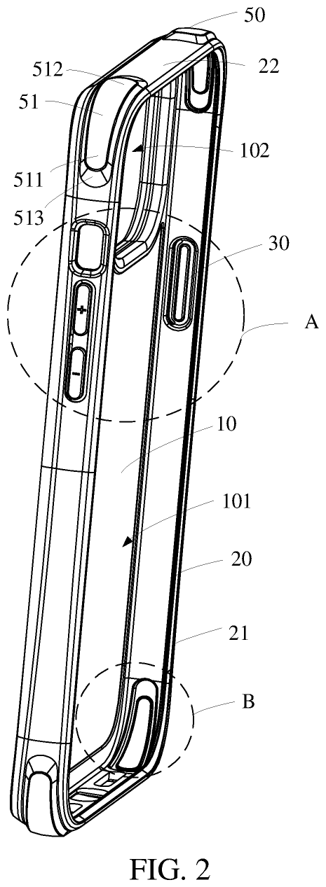

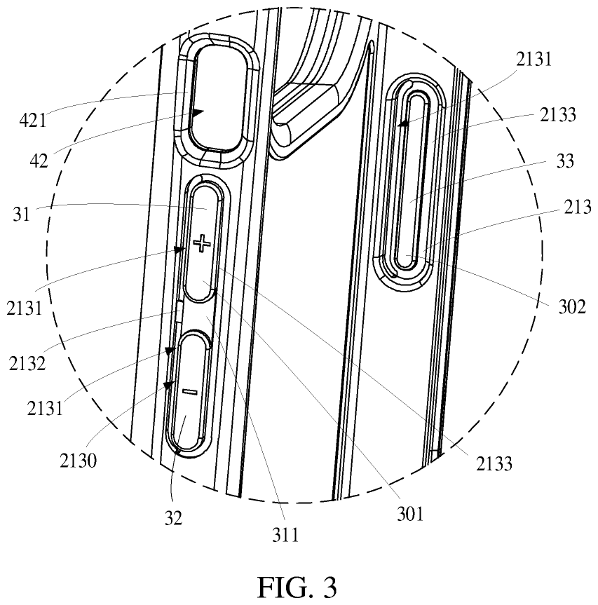

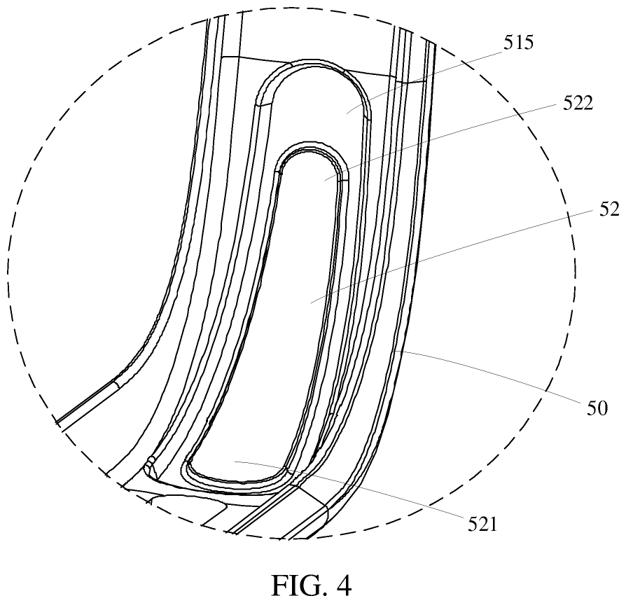

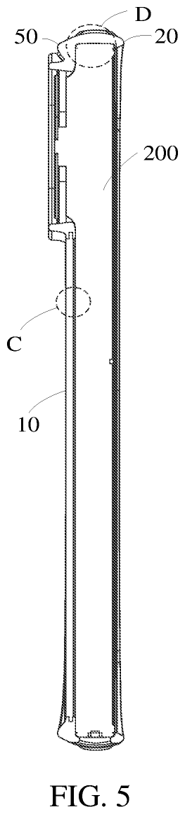

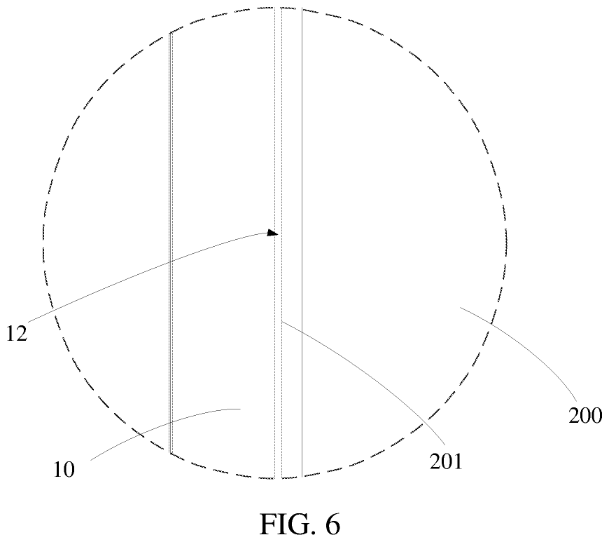

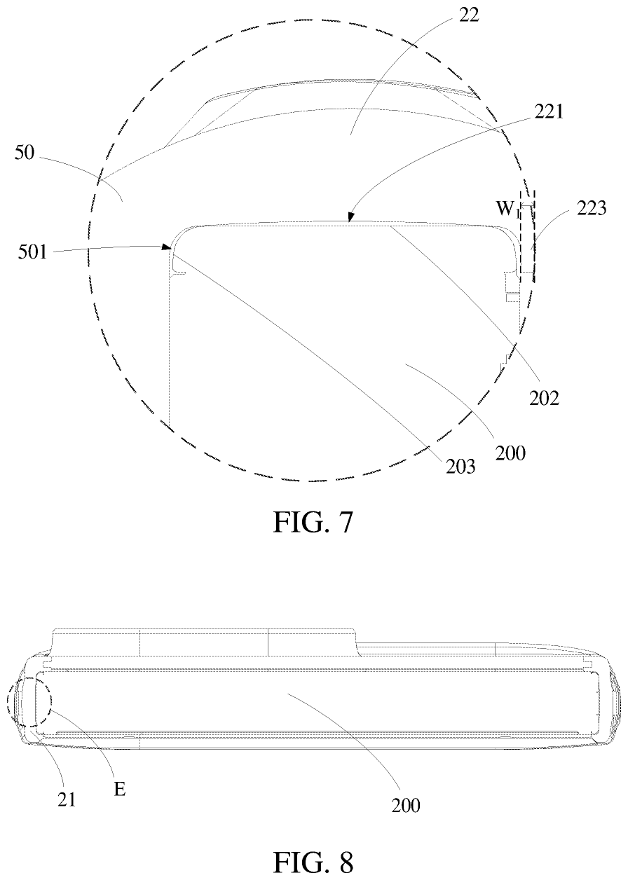

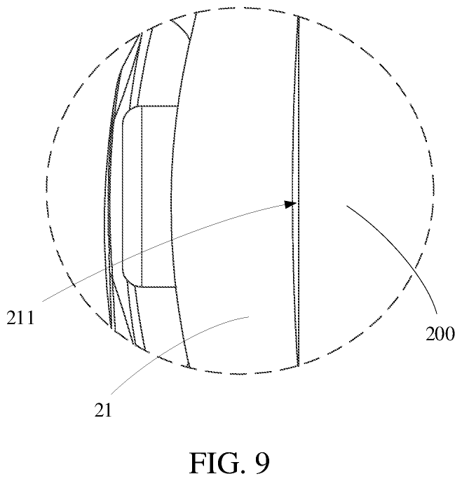

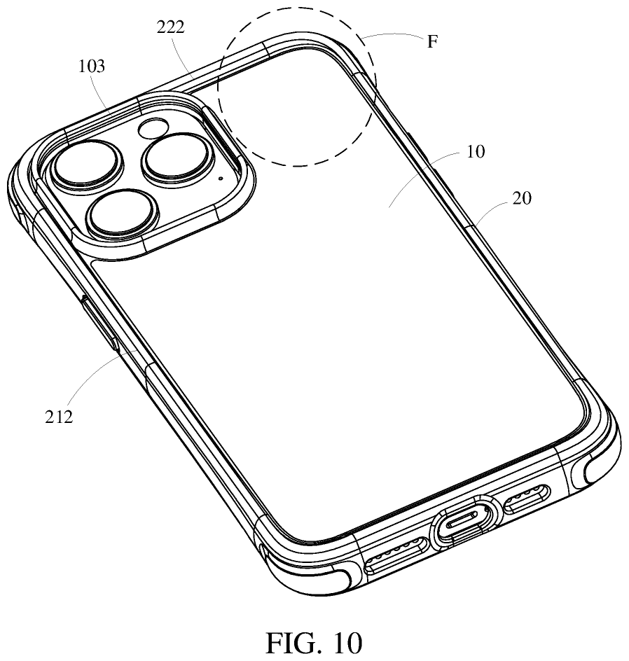

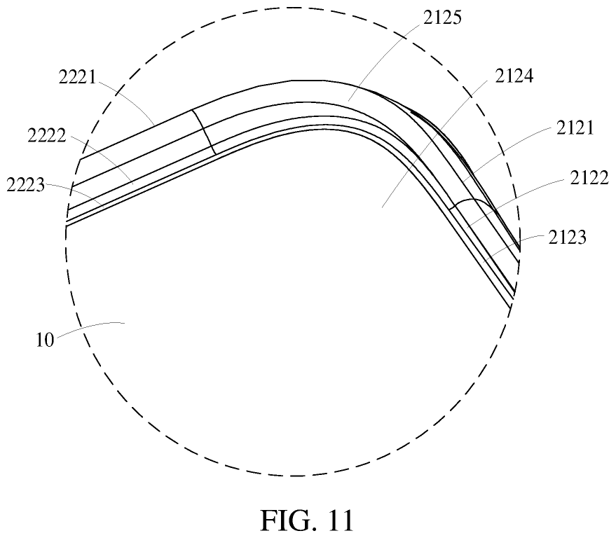

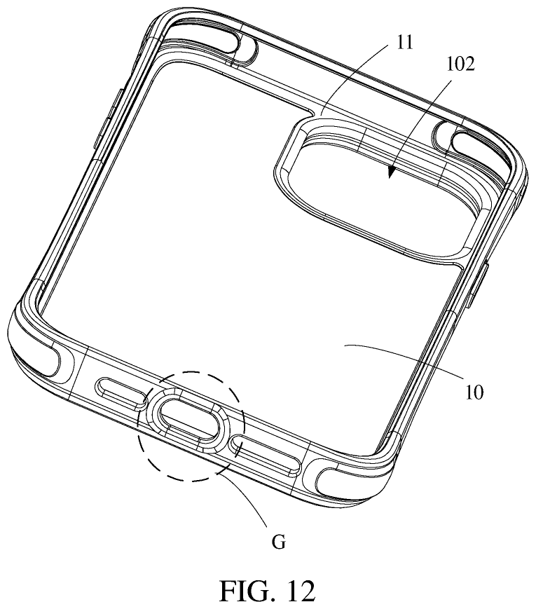

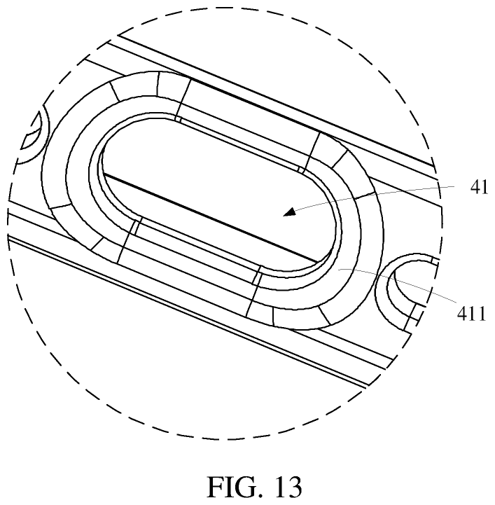

Referring to FIG. 1 to FIG. 13, the present disclosure provides a protective case 100 according to an embodiment. The protective case 100 is used to cover an electronic device 200 to protect the electronic device 200.

The protective case 100 includes a bottom wall 10 and a side wall 20, the side wall 20 is connected with the bottom wall to define a receiving space 101.

The bottom wall 10 is protruded with a step 11 configured for supporting the electronic device 200, such that when the electronic device 200 is received in the receiving space 101, a first gap 12 is defined between the bottom wall 10 and a bottom wall 201 of the electronic device 200. An inner surface of the side wall 20 is arc-shaped, such that when the electronic device 200 is received in the receiving space 101, a second gap is defined between the inner surface of the side wall 20 and sidewalls 202 of the electronic device 200. The first gap 12 and the second gap can be defined as heat dissipation spaces and help to dissipate heat generated by the electronic device 200, and for preventing the moisture from attaching to the electronic device 200 to form water stains on the electronic device 200.

A height of the step 11 is about 0.2-0.8 millimeters, for example, the height of the step 11 is 0.2 millimeters, 0.3 millimeters, 0.4 millimeters, 0.5 millimeters, 0.6 millimeters, 0.7 millimeters, or 0.8 millimeters. A width of the first gap 12 is about 0.1-0.5 millimeters, for example, the width of the first gap 12 is 0.1 millimeters, 0.2 millimeters, 0.3 millimeters, 0.4 millimeters, or 0.5 millimeters. The step 11 surrounds an edge of the bottom wall 10. The protective case 100 defines a through hole 102 corresponded with a camera (not labeled) of the electronic device 200, the step 11 also surrounds an edge of the through hole 102.

The side wall 20 includes two opposite first side walls 21 and two opposite second side walls 22, the first side walls 21 connect with the second walls 22. A length of the first side wall 21 is not less than that of the second side wall 22. In one embodiment, the length of the first side wall 21 is greater than that of the second side wall 22. An inner surface of the first side wall 21 is arc-shaped, and the second gap includes a gap 211 defined between the electronic device 200 and the inner surface of the first side wall 21. An inner surface of the second side wall 22 is arc-shaped, and the second gap further includes a gap 221 defined between the electronic device 200 and the inner surface of the second side wall 22. A width of the gap 211 defined between the electronic device 200 and the inner surface of the first side wall 21 is about 0.1-0.5 millimeters, for example, the width of the gap 211 is 0.1 millimeters, 0.2 millimeters, 0.3 millimeters, 0.4 millimeters, or 0.5 millimeters. A width of the gap 221 defined between the electronic device 200 and the inner surface of the second side wall 22 is about 0.1-0.5 millimeters, for example, the width of the gap 221 is 0.1 millimeters, 0.2 millimeters, 0.3 millimeters, 0.4 millimeters, or 0.5 millimeters.

An outer surface of the first side wall 21 includes an arc-shaped structure 210, the arc-shaped structure includes a concave middle portion. In one embodiment, the two opposite first side walls 21 have the concave middle portion 210, and the protective case 100 in consequence substantially has a waist shape or a hourglass shape. A radian of the arc-shaped structure is about 0.8-1.5, for example, the radian of the arc-shaped structure is 0.8, 0.9, 1, 1.1, 1.2, 1.3, 1.4, or 1.5.

The first side wall 21 further includes a first support portion 212 configured for supporting the protective case 100, and the first support portion 212 inclines gradually in a direction close to the bottom wall 10. The first support portion 212 includes a first end 2121, a first inclined surface 2122, and a first connecting end 2123, the first inclined surface 2122 is connected between the first end 2121 and the first connecting end 2123. The first end 2121 has a higher height than the other parts of the first support portion 212, and the first inclined surface 2122 inclines gradually in a direction from the first end 2121 to the first connecting end 2123. The first connecting end 2123 is substantially flat and connected with the bottom wall 10.

The second side wall 22 includes a second support portion 222 connected with the first support portion 212 and configured for supporting the protective case 100, and the second support portion 222 inclines gradually in a direction close to the bottom wall 10. The second support portion 222 includes a second end 2221, a second inclined surface 2222, and a second connecting end 2223, the second inclined surface 2222 is connected between the second end 2221 and the second connecting end 2223. The second end 2221 has a higher height than the other parts of the second support portion 222, and the second inclined surface 2222 inclines gradually in a direction from the second end 2221 to the second connecting end 2223. The second connecting end 2223 is substantially flat and connected with the bottom wall 10.

The first support portion 212 and the second support portion 222 surround an edge of the bottom wall 10, and the first support portion 212, the second support portion 222, and the bottom wall 10 cooperatively form a recessed structure 2124. A connecting portion 2125 of the first support portion 212 and the second support portion 222 is arc-shaped. The first support portion 212 and the second support portion 222 directly contact with and the table when the protective case 100 is placed on a table, and the bottom wall 10 does not contact with the table to prevent scratching or soiling the bottom wall 10. In addition, the first support portion 212 and the second support portion 222 give a better sense of grip, and the grip feel is very real.

The protective case 100 further includes a third support portion 103 protruded from the outer surface of the bottom wall 10 and surrounding the edge of the through hole 102. The third support portion 103 can isolate the camera of the electronic device 200 from the table and prevent scratching or soiling the camera. In one embodiment, a height of the third support portion 103 is greater than that of the first support 212 or the second support portion 222, and an angle may be defined between the protective case 100 and the table when placed on the table.

A free end of the side wall is protruded with a fixing portion 223 surrounding the free end of the side wall, the fixing portion 223 is configured to prevent the electronic device from sliding out of the receiving space 101. In an embodiment, the fixing portion 223 presses on the electronic device 200 to prevent the electronic device 200 from sliding out of the receiving space 101. In another embodiment, the fixing portion 223 is does not press on the electronic device 200 when the electronic device 200 is horizontally received in the receiving space 101. A width W₁ of the fixing portion 223 is about 0.8-1 millimeters, for example, the width of the fixing portion 223 is 0.8 millimeters, 0.9 millimeters, or 1 millimeters. In detail, the fixing portion 223 surround edges of the first side walls 21 and the second side walls 22, and extends towards a center of the bottom wall 10.

The protective case 100 further includes at least one button portion 30 arranged on the side wall and corresponded to at least one button (not labeled) of the electronic device 200. In one embodiment, the at least one button portion 30 includes a volume up button portion 31, a volume drop button portion 32, and a switch button portion 33. A first end 301 of the at least one button portion 30 protruding from the outer surface of the side wall has a height of about 0.5-1 millimeters, for example, the first end 301 of the at least one button portion 30 protruding from the outer surface of the side wall has the height of 0.5 millimeter, 0.6 millimeter, 0.7 millimeter, 0.8 millimeter, 0.9 millimeter, or 1 millimeter. A second end 302 of the at least one button portion 30 is flush with an inner surface of the side wall or extended out of the inner surface of the side wall.

The side wall defines at least one opening 2130, the at least one button portion 30 is partially received in the opening 2130, and the first end 301 of the at least one button portion 30 protruding from the opening 2130 has a height of about 0.5-1 millimeters.

A third gap 2131 is defined between a first wall of the opening 2130 and a first side of the button portion 30. User can easily press the button portion 30 due to the existence of the third gap 2131. The volume up button portion 31 and the volume drop button portion 32 are received in the same opening 2130, the volume up button portion 31 is connected with the volume drop button portion 32 by a connecting portion 311. The connecting portion 311 is also received in the opening 2130. A connecting portion 2132 is received in the third gap 2131 and connected between the first wall of the opening 2130 and the connecting portion 311. A connecting portion 2133 is connected between a second wall of the opening 2130 and the volume up button portion 31, and connected between the second wall of the opening 2130 and the volume drop button portion 32. An end of the connecting portion 311 away from the connecting portion 2132 is connected with the connecting portion 2133.

The switch button portion 33 is also received in the corresponding opening 2130. The third gap 2131 is defined between the first wall of the opening 2130 and a first side of the switch button portion 33, and the connecting portion 2133 is connected between the second wall of the opening 2130 and a second side of the switch button portion 33. The protective case 100 further includes four corners 50. A fourth gap 501 is defined between a corner 203 of the electronic device 200 and an inner surface of the corner 50 when the electronic device 200 is received in the receiving space 101. A width of the fourth gap 501 is about 0.1-0.5 millimeters, for example, the width of the fourth gap 501 is 0.1 millimeters, 0.2 millimeters, 0.3 millimeters, 0.4 millimeters, or 0.5 millimeters. The fourth gap 501 can be defined as the heat dissipation space and helps to dissipate heat generated by the electronic device 200, for preventing the moisture from attaching to the electronic device 200 to form water stains on the electronic device 200.

Each corner 50 is protruded with a protrusion 51. The protrusion 51 may protect the electronic device 200 in case of falling. The protrusion 51 includes a first end 511 and a second end 512, a size of the second end 512 is greater than that of the first end 511, and a size of the protrusion 51 gradually increase in a direction from the first end 511 to the second end 512. The protrusion 51 further includes a connecting portion 513 connected with the corner 50 and inclined gradually in a direction close to the corner 50.

An inner side of the corner 50 defines a receiving groove 515, another protrusion 52 is received in the receiving groove 515 and partially extended out of the receiving groove 515. In one embodiment, the fourth gap 501 is defined between the protrusion 52 and the electronic device 200. The protrusion 52 includes a third end 521 and a fourth end 522, a size of the third end 521 is greater than that of the fourth end 522, and a size of the protrusion 52 gradually increase in a direction from the fourth end 522 to the third end 521.

The second side wall 22 defines a first through hole 41 corresponded with a charging part (not labeled) of the electronic device 200, a wall 411 of the first through hole 41 inclines gradually in a direction close to a center of the first through hole 41. In this way, a charging interface of a charger can be easily inserted into the charging part of the electronic device 200 along the inclined wall 411.

The first side wall 21 defines a second through hole 42 corresponded with a mute button (not labeled) of the electronic device 200, a wall 421 of the second through hole 42 inclines gradually in a direction close to a center of the second through hole 42. In this way, user can move the mute button easily.

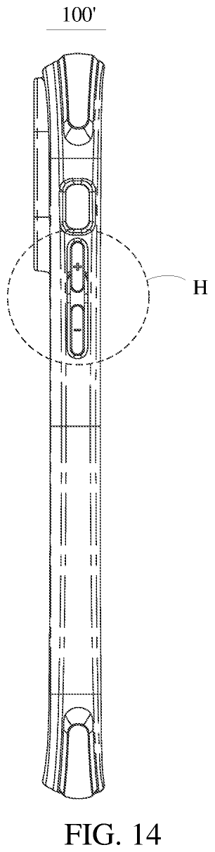

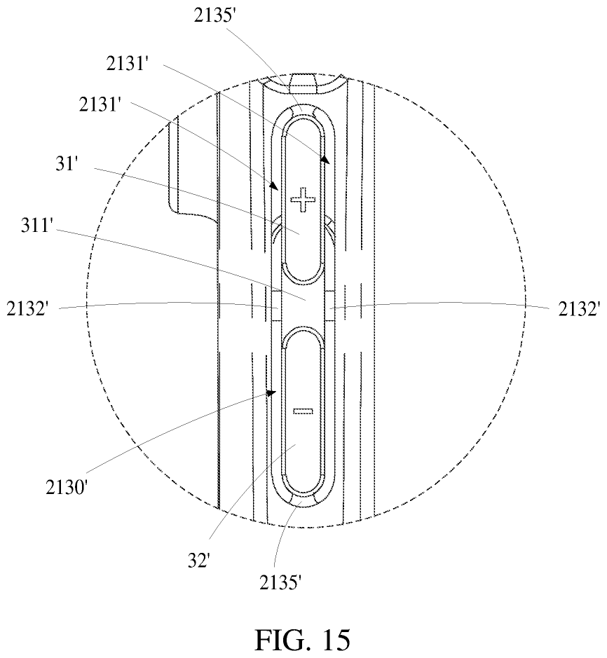

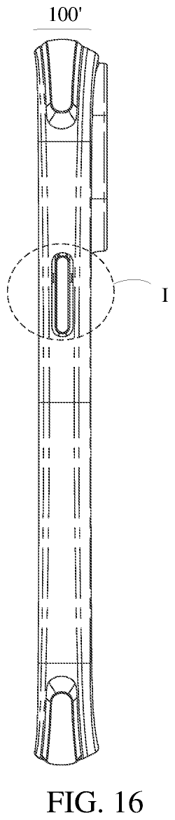

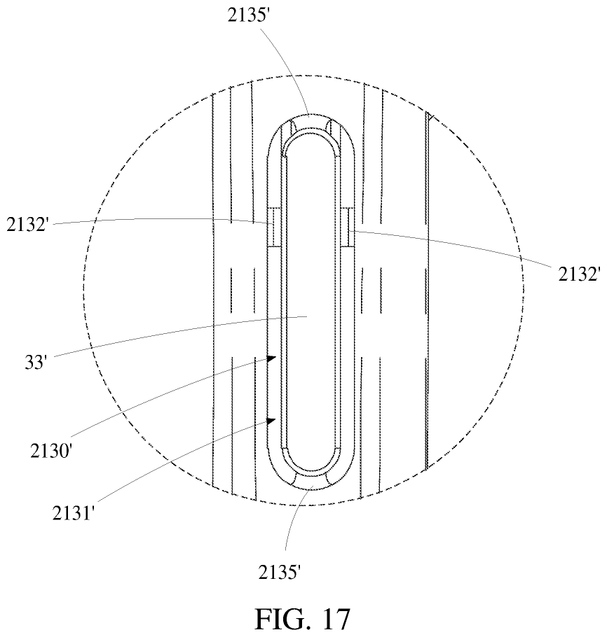

Referring to FIG. 14 to FIG. 17, the present disclosure further provides a protective case 100′ according to a second embodiment, the protective 100′ is similar to the protective case 100 in structure, and the differences between the two at least include: there are two opposite connecting portions 2132′ and two third gap 2131′, each connecting portion 2132′ is received in one corresponding third gap 2131′ and connected between the connecting portion 311′ and the side wall of the opening 2130′; there are also two opposite connecting portions 2135′ received in the opening 2130′, one of the two connecting portions 2135′ is connected between the volume up button portion 31′ and the side wall of the opening 2130′, the other of the two connecting portions 2135′ is connected between the volume drop button portion 32′ and the side wall of the opening 2130′, and the two third gaps 2131′ are separated from each other by the two connecting portions 2135′.

In one embodiment, the switch button portion 33′ is received in the opening 2130′, there are two opposite connecting portions 2132′ and two opposite connecting portions 2135′, each connecting portion 2132′ is received in one corresponding third gap 2131′ and connected between the switch button portion 33′ and the side wall of the opening 2130′, each connecting portion 2132′ is connected between the switch button portion 33′ and the side wall of the opening 2130′. In one embodiment, the connecting portions 2132′ and the connecting portions 2135′ separate the two third gaps 2131′ into four sub gaps.

It should be understood that the present disclosure does not limit the quantities of the above connecting portions.

The present disclosure further provides an electronic device 200 including a housing (not labeled) and the protective case 100/100′, the housing is detachably received in the receiving space 101. The electronic device 200 further includes a main body (not labeled), the main body includes CPU, display screen, camera, battery, sensor, and so on. The electronic device 200 may be phone, tablet, TV, game console, and the like.

The above description is merely some embodiments. It should be noted that for one with ordinary skills in the art, improvements can be made without departing from the concept of the present disclosure, but these improvements shall fall into the protection scope of the present disclosure.

1. A protective case, applied to an electronic device, comprising:
a bottom wall; and
a side wall, connected with the bottom wall to define a receiving space, and
a step configured for supporting the electronic device, wherein,
the step is protruding, from an inner surface of the bottom wall facing the receiving space, towards the receiving space; the protruding step is spaced apart from the side wall;
a first gap is defined between the bottom wall of the protective case and a bottom wall of the electronic device when the electronic device is received in the receiving space;
wherein an inner surface of the side wall facing towards the receiving space and sidewall of the electronic device is arc-shaped, and a second gap is defined between the inner surface of the side wall and the sidewall of the electronic device when the electronic device is received in the receiving space.

2. The protective case according to claim 1, wherein
the step at least partially surrounds an edge of the bottom wall; and/or
a height of the step is about 0.2-0.8 millimeters; and/or
a width of the first gap is about 0.1-0.5 millimeters; and/or
the protective case further includes at least one corner protruded with a protrusion.

3. (canceled)

4. The protective case according to claim 1, wherein the side wall comprises a first side wall and a second side wall, a length of the first side wall is not less than that of the second side wall, wherein
an inner surface of the first side wall is arc-shaped, and the second gap comprises a gap defined between the inner surface of the first side wall and corresponding sidewall of the electronic device; and/or
an inner surface of the second side wall is arc-shaped, and the second gap comprises a gap defined between the inner surface of the second side wall and corresponding sidewall of the electronic device.

5. The protective case according to claim 4, wherein
a width of the gap defined between the inner surface of the first side wall and corresponding sidewall of the electronic device is about 0.1-0.5 millimeters; and/or
a width of the gap defined between the inner surface of the second side wall and corresponding sidewall of the electronic device is about 0.1-0.5 millimeters.

6. The protective case according to claim 1, wherein the side wall comprises a first side wall, an outer surface of the first side wall comprises an arc-shaped structure, the arc-shaped structure comprises a concave middle portion.

7. The protective case according to claim 1, wherein the side wall comprises a first side wall, the first side wall comprises a first support portion configured for supporting the protective case.

8. The protective case according to claim 1, wherein the side wall further comprises a second side wall, the second side wall comprises a second support portion configured for supporting the protective case.

9. The protective case according to claim 7, wherein the side wall further comprises a second side wall, a length of the first side wall is not less than that of the second side wall, the second side wall comprises a second support portion configured for supporting the protective case, and the second support portion is connected with the first support portion.

10. The protective case according to claim 1, wherein a free end of the side wall is protruded with a fixing portion, the fixing portion presses on the electronic device to prevent the electronic device from sliding out of the receiving space.

11. The protective case according to claim 1, further comprising:
at least one button portion, arranged on the side wall and corresponded to a button of the electronic device.

12. The protective case according to claim 11, wherein a first end of the at least one button portion protruding from the side wall has a height of about 0.5-1 millimeters.

13. The protective case according to claim 12, wherein the side wall defines an opening, the at least one button is partially received in the opening, wherein
the first end of the at least one button protruding from the opening has the height of about 0.5-1 millimeters; and/or
a second end of the at least one button portion is flush with an inner surface of the side wall or extended out of the inner surface of the side wall.

14. The protective case according to claim 11, wherein the side wall defines at least one opening, the at least one button is partially received in the at least one opening, and at least one third gap is defined between a wall of the at least one opening and a side of the at least one button portion.

15. The protective case according to claim 14, wherein the at least one button portion comprises a volume up button portion and a volume drop button portion, the volume up button portion and the volume drop button portion are received in the same opening, the volume up button portion is connected with the volume drop button portion by a first connecting portion.

16. The protective case according to claim 15, further comprising:
at least one second connecting portion, received in the third gap and connected between the wall of the opening and the first connecting portion.

17. The protective case according to claim 16, further comprising:
at least one third connecting portion, connected between the wall of the opening and the at least one button portion.

18. The protective case according to claim 1, further comprising:
a first corner, a fourth gap is defined between a second corner of the electronic device and an inner surface of the first corner when the electronic device is received in the receiving space.

19. The protective case according to claim 1, wherein the protective case defines a through hole corresponded with a charging part of the electronic device, a wall of the through hole inclines gradually in a direction close to a center of the through hole.

20. An electronic device, comprising a housing and a protective case according to claim 1, wherein the housing is detachably received in the receiving space; and
wherein the side wall comprises two long walls parallel and opposite to each other and two short walls parallel and opposite to each other, the two short walls are disposed and connected between the two long walls;
a corner is formed at a connection at which each of the two long walls is connected to one of the two short walls;
a first protrusion is arranged on an outer surface of the corner and protruding away from the receiving space, and a second protrusion is arranged on an inner surface of the corner and protruding towards the receiving space;
the first protrusion has a first end arranged on a respective one of the two long walls and a second end arranged on a respective one of the two short walls, a size of the first end is smaller than a size of the second end;
the second protrusion has a third end arranged on a respective one of the two long walls and a fourth end arranged on a respective one of the two short walls, a size of the third end is smaller than a size of the fourth end.
